(19) United States
(12) Patent Application Publication
(10) Pub. No.: US 2006/0006666 A1
(43) Pub. Date: Jan. 12, 2006

(54) Inside latch structure

(76) Inventor: Ku Long Lin, Taichung (TW)

Correspondence Address: Liberty Patent and Trademark Office, P.O. Box 590, Taichung, 400, TW

(21) Appl. No.: 10/883,800

(22) Filed: Jul. 6, 2004

(51) Int. Cl. E05C 3/06

(52) U.S. Cl. 292/200

(57) ABSTRACT

An inside latch structure includes a base unit, a holder unit, a nose and a lever. The base unit is installed on one side of a doorplate. The holder unit is assembled on the base unit and capable of rotating at 360 degrees in relation to the base unit. The nose unit and the lever are hinged to the holder unit. One end of the lever has a formation of a protrusion unit that is in close contact with the nose unit. A spindle is assembled between two inside latches to keep the holder unit from rotating in relation to the base unit. By turning the lever of one inside latch, the spindle drives the lever of another inside latch, forming a turned status. When the lever is pressed, the protrusion unit drives the nose unit, causing the nose unit to retract into the holder unit. Formed at one end of the lever is a lever unit. When the lever unit is pushed during operating, the lever swings towards the base unit, causing the protrusion unit to drive the nose unit to retract into the lever. Thereby, the holder unit and the lever are capable of free rotation in relation to each other to reduce the measurements required for packaging, also by means of one spindle drives both inside latches and the design of the protrusion unit and the lever unit could make versatile usage with the inside latch.

### BACKGROUND OF THE INVENTION

1. Field of the Invention

The present invention relates to an inside latch structure, particularly an inside latch having a nose. The inside latch is normally installed on one side of a outswing screen and storm door; by means of the nose of the inside latch against a strike that is installed on a surface of a doorframe to provide restricting purpose. To open the door, the user has to turn the lever or press the lever of the inside latch to remove the restriction provided by the nose unit; or, another inside latch is used to remove restriction of the nose.

2. Prior Art

A inside latch is assembled on a doorplate to provide latching purposes, so when the doorplate is in a closed status, the user has to turn the inside latch to remove the latching mechanism and open the door.

Conventionally, a doorplate has two inside latches, one installed on the outside of a doorplate, the other installed on the inside of the doorplate. An example is given in the U.S. Pat. No. 5,529,354, disclosing a first inside latch consisting of a main unit and an lever, and a second inside latch consisting of a main unit and an lever, but provided on the lever are a nose unit and a matching strike to provide engagement function. By turning the lever of either one inside latch, the nose unit is disengaged from the strike, so the door can be opened.

Another pending patent in U.S. PTO No. 2004/0070216 A1 discloses another type of inside latch structure, wherein in addition to the feature that the nose unit and the strike can be disengaged by turning the lever, which is a same feature shared by the foregoing patent, the nose unit and the strike can also be disengaged by pressing on the lever.

The levers of the inside latches in the above American patents are capable of automatically reset to their original positions after being turned, because there is a resilient resetting device installed in the inside latch. Since the lever, the resilient resetting device and the main unit are assembled in the inside latch, the lever could not rotate at 360 degrees in relation to the main unit, therefore the length of the main unit is vertical to the length of the lever, resulting in larger packing box measurements to accommodate the inside latch product.

Besides, with the inside latch equipped with a nose unit as described above, the nose unit will not retract unless the lever is turned or the lever is pressed from inside the door. With the trend of variability in use, however, it has become necessary to design a new mechanism wherein the nose unit is capable of retracting by operating the door latch from outside the door.

### SUMMARY OF THE INVENTION

It is a first objective of the present invention to provide an inside latch structure, which is capable of reducing its packaging measurements.

It is a second objective of the present invention to provide an inside latch structure, which is capable of disengaging the nose unit from the strike by turning or pressing the lever.

It is a third objective of the present invention to provide an inside latch structure, which is capable of retracting the nose unit inside the inside latch by pressing on a push knob on the outside of the inside latch.

To achieve the purpose of reducing the packaging measurements, a base unit and a holder unit are hinged in the inside latch. Installed inside the base unit is a resilient resetting device. The resilient resetting device and the holder unit are not joined together. By hinging the lever on the holder unit, the lever and the holder unit are capable of rotating at 360 degrees in relation to the base unit, therefore the lever installed on the holder unit can be positioned parallel to the base unit, to achieve the purpose of reducing its packaging measurements.

To enable the nose unit to retract when the lever is turned, a spindle is inserted through the base unit and the holder unit. The spindle penetrates through the resilient resetting device, restricting the rotating angles of the lever and the holder unit in relation to the base unit. Meanwhile, turning of the lever will disengage the nose unit on the holder unit and the strike on the doorframe.

Besides, to disengage the nose unit from the strike on the doorframe by pressing on the lever, there is a protrusion unit on the lever. The protrusion unit and the nose unit are joined as one unit. When the lever is pressed, the protrusion unit drives the nose unit to disengage from the strike.

Optionally, to enable control from the outside of the door to drive the nose unit to retract, there is a lever unit formed on the lever. When an outside force pushes the lever unit, it drives the protrusion unit to retract the nose unit. The source of the aforesaid outside force applied on the lever unit can be produced by a spindle installed in the door handle outside the door, moving and pushing the lever unit.

For better understanding of the objectives, functions and structural configurations of the present invention, please refer to the preferred embodiment and accompanying drawings.

### BRIEF DESCRIPTION OF THE DRAWINGS

The other objects and features of the present invention can be more fully understood by referring to the following description of preferred embodiments and accompanying drawings, in which

FIG. 1 is an exploded view of the present invention.

FIG. 2 is an exterior view of the present invention when assembled.

FIG. 3 is a schematic view of the present invention when assembled.

FIG. 4 is a schematic view of the lever and holder unit in operation.

FIG. 5 is an exploded view of the present invention when assembled in use.

FIG. 6 is a schematic view of the present invention when assembled in use.

FIG. 7 is a schematic view of the present invention when the lever is turned.

FIG. 8 is a schematic view of the present invention when the lever is pressed.

FIG. 9 is a schematic view of the present invention when pushed by a spindle.

### DETAILED DESCRIPTION OF PREFERRED EMBODIMENTS

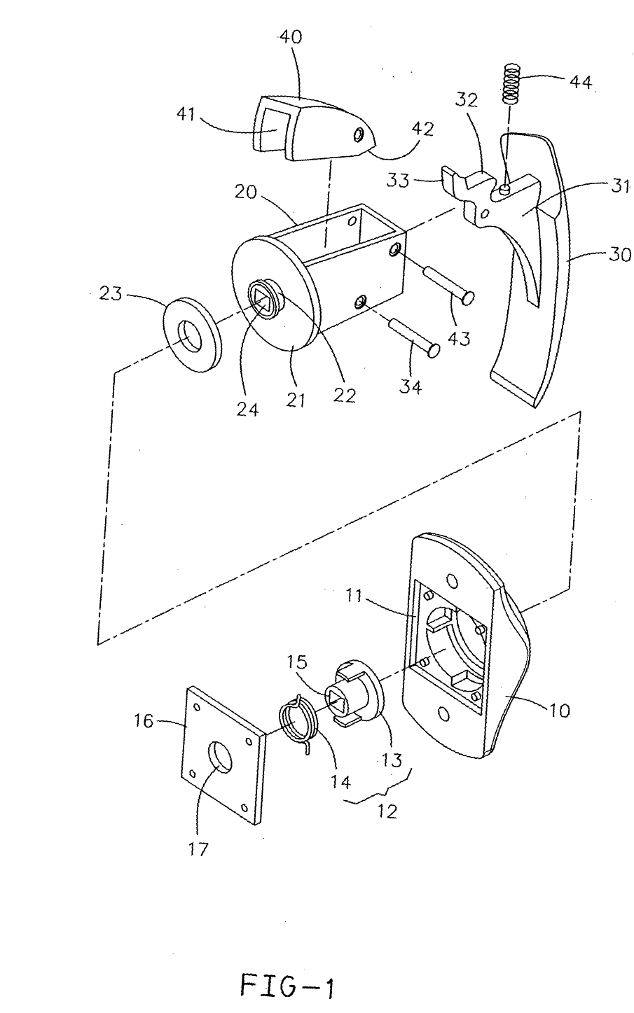

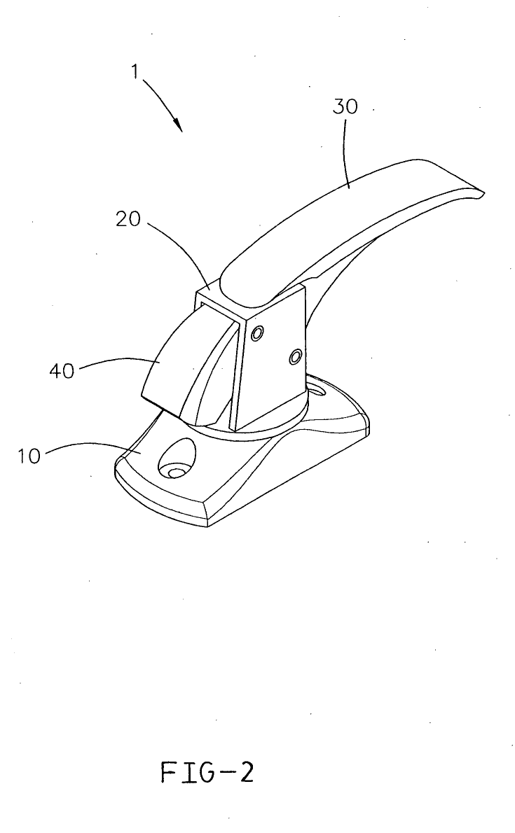

Please refer to FIGS. 1 and 2. The present invention of inside latch 1 is comprised of a base unit 10, an holder unit 20, an lever 30 and a nose 40.

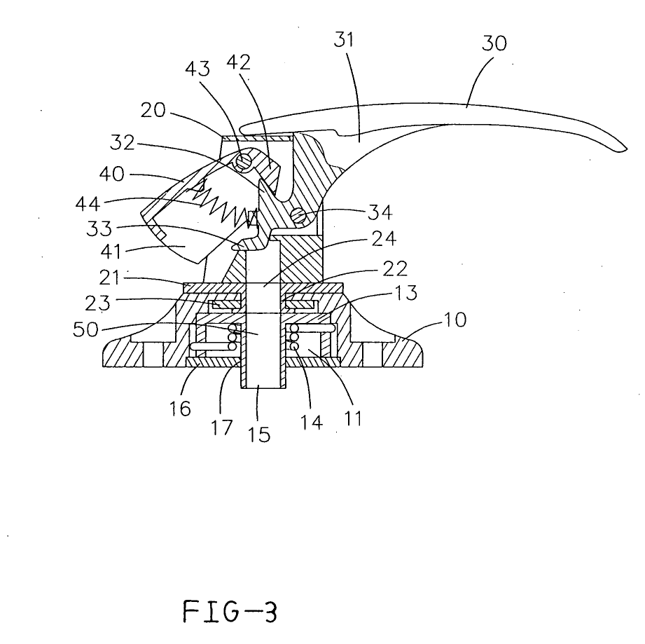

As shown in FIGS. 1 and 3, the base unit 10 has a through assembling space 11. Provided at an end face 21 of the holder unit 20 is a shaft unit 22. The shaft unit 22 is inserted through the base unit 10 into the assembling space 11. A pad 23 is riveted to the shaft unit 22, thereby fixing the holder unit 20 onto the base unit 10, but enabling 360-degree rotation.

A resilient resetting device 12 includes a rotor 13 and a torsion spring 14. The rotor 13 and the torsion spring 14 are assembled together inside the assembling space 11. Since one end of the torsion spring 14 is in contact with the rotor 13, while another end of the torsion spring 14 is in contact with the wall of the assembling space 11, when the torsion spring 14 rotates with the rotor 13, the torsion spring 14 provides resiliency to the rotor 13, thereby resetting the rotor 13 to its original position.

Provided at the axis of the rotor 13 is a through hole 15; provided at the axis of the shaft unit 22 is another through hole 24. The holder unit 20 is assembled on the base unit 10, and the resilient resetting device 12 is assembled in the assembling space 11, so the holes 15, 24 form a communicating through channel 50. Another sealing cap 16 is used to seal the opening of the assembling space 11. On the surface of the sealing cap 16 is provided a through hole 17 to allow penetration of one end of the rotor 13.

On the bottom at one end of the lever 30 is a hinge unit 31. One end of the hinge unit 31 is the formation of a protrusion unit 32 and a lever unit 33. The protrusion unit 32 and the lever unit 33 are opposite and matching each other. Using the hinge unit 31, the lever 30 is attached to the holder unit 20 and hinged on a hinge shaft 34, so the lever 30 could rotate.

A nose 40 has one side open to form a hollow chamber 41. On one end of the hollow chamber 41 is a formation of a stopper unit 42. The nose 40 is assembled onto the holder unit 20 and hinged on a hinge shaft 43, so the nose 40 could rotate.

Importantly, in the assembly of the lever 30, the nose 40 and the holder unit 20, the protrusion unit 32 is engaged to the stopper unit 42. The lever unit 33 is aligned with an end of the through channel 50 formed by the through holes 15, 24. The protrusion unit 32 and the stopper unit 42 are engaged to a position between the hinged nose 40 and the hinged lever 30. Installed between the hinge unit 31 and the nose 40 is a resetting spring 44 to enable extension of one end of the nose 40 out of the holder unit 20 without the influence of a foreign force.

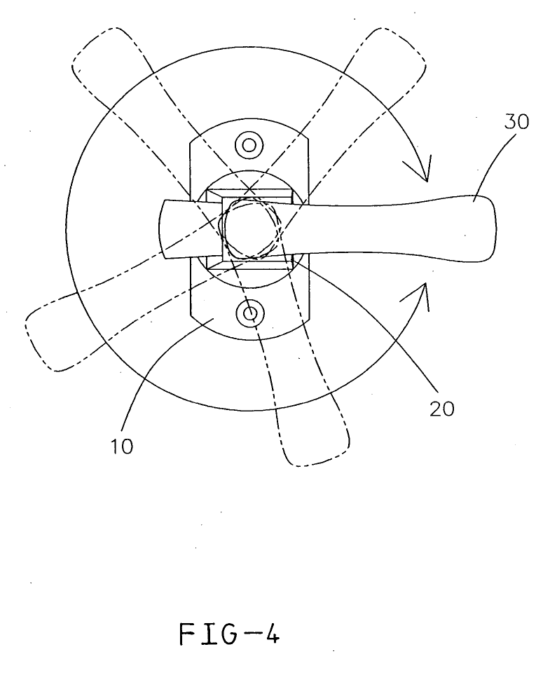

Please refer to FIG. 2 that illustrates an exterior view of the inside latch consisting of the base unit 10, the holder unit 20, the lever 30 and the nose 40. As shown in FIG. 4, it is known from the foregoing description that the holder unit 20 and the base unit 10 are capable of rotating at any angle. So the lever 30 can be adjusted to a position parallel to the base unit 10, thereby reducing the length and width of the packing box for the inside latch, and minimizing its packaging measurements.

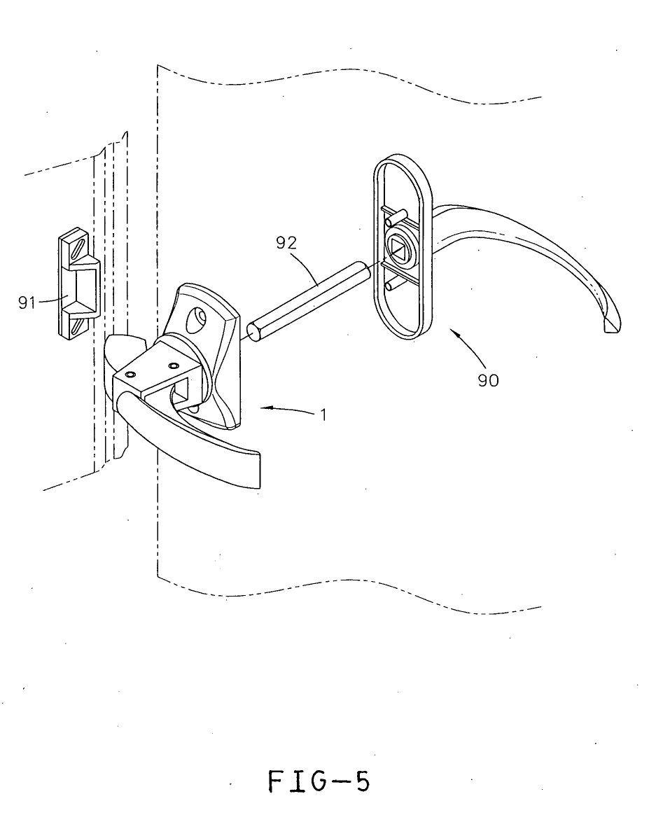

Please refer to FIG. 5. A latch is used as a unit to include an outside lever handle 90 installed on the outside of the door and an inside latch 1 installed on the inside of the door. The inside latch installed on the inside of the door is the subject of invention disclosed herein. A spindle 92 is installed between the two inside latches 1, 90. A strike 91 is formed in the shape of a recess on the doorframe.

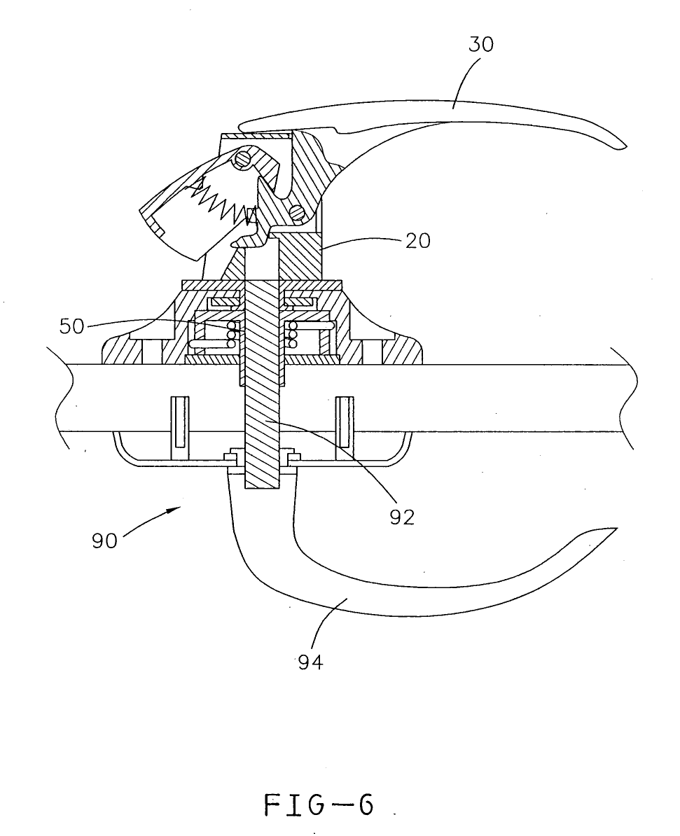

As shown in FIG. 6, one end of the spindle 92 is inserted inside the through channel 50, thereby the holder unit 20 is restricted by the spindle 92 and could not rotate. Meanwhile, in the configuration disclosed in FIG. 3, the holder unit 20 and the lever 30 are not restricted by the spindle 92, therefore they are capable of rotating freely.

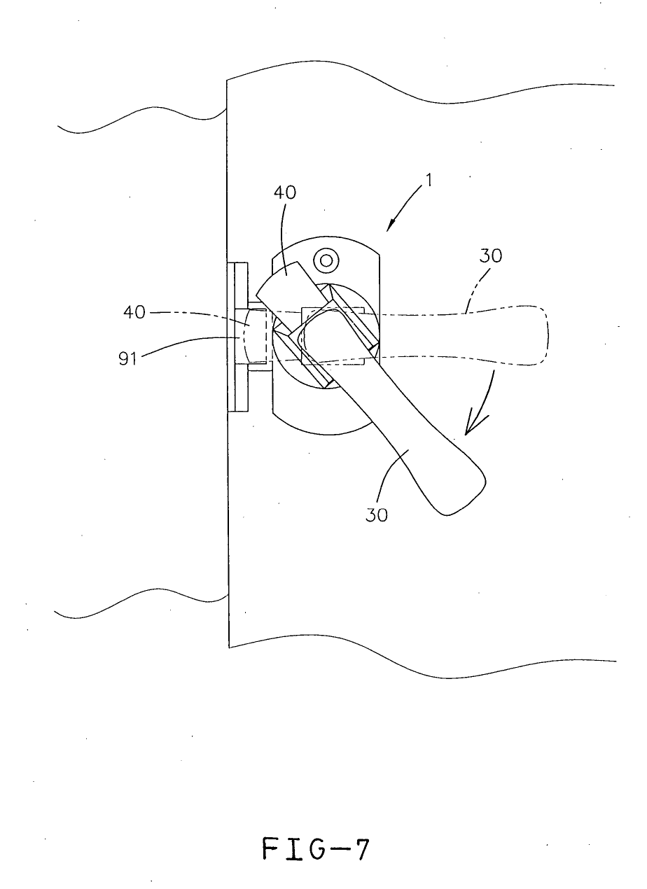

As shown in FIG. 6, when the user turns the lever 30, an lever 94 on the other outside lever handle 90 is also turned. Likewise, the user is capable of turning the other lever 30 by controlling the lever 94. As shown in FIG. 7, when the user turns the lever 30, the nose 40 is separated from the strike 91, so the door can be opened.

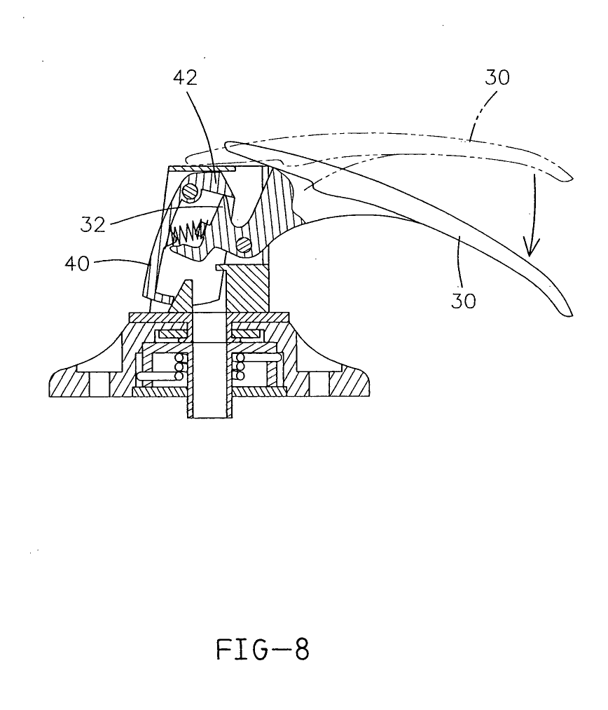

As shown in FIG. 8, when the user press the lever 30, the protrusion unit 32 pushes against the stopper unit 42, so the nose 40 retracts into the holder unit 20, thereby removing the restriction when the nose 40 is in an extended status.

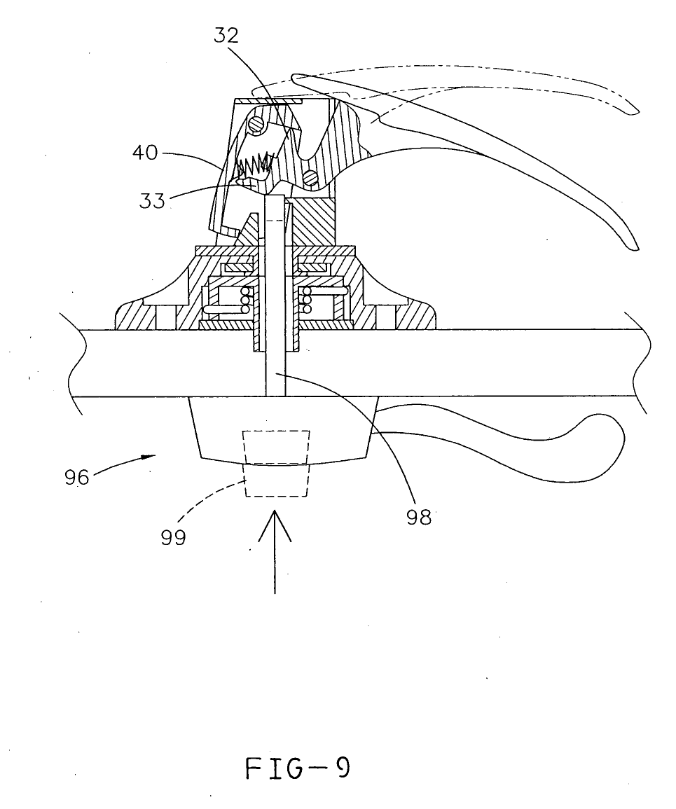

Please refer to FIG. 9 that illustrates a varied application of the present invention when the door is opened by pressing on the handle. Installed between the outside push handle 96 and the inside latch 1 is a spindle 98. One end of the spindle 98 is connected with a push button 99 of the outside push handle 96. Another end of the spindle 98 is in contact against the lever unit 33. Thereby, when the user press the push button 99, the spindle 98 in turn pushes the lever unit 33; then, the protrusion unit 32 drives the nose 40 to retract into the holder unit 20, removing the restriction when the nose 40 is in an extended status.

As disclosed above in the foregoing embodiments, the present invention is capable of reducing its packaging measurements. In actual operation, the invention has provided functions including: the user is capable of rotating the lever, press the lever, and pressing the push knob on another inside latch to activate a spindle pushing the lever to retract the nose unit. Therefore, the present invention has a conspicuous inventive step in its packaging and application.

It is to be understood that the above preferred embodiments and design drawings are for the purpose of explanation; they should not be based to restrict or limit the claim of the present invention, and that all equivalent skills and approaches adopted without departing from the spirit and intent of the present invention shall be included in the following claim.

What is claimed is:

1. A inside latch structure, comprising:
a base unit, assembled on one side of a door plate, having a resilient resetting device;
a holder unit, assembled on the base unit, capable of 360-degree rotation in relation to the base unit;
a nose, hinged on the holder unit; and
a lever, hinged on the holder unit, having one end thereof in contact with the nose unit;
wherein, on the lever are formation of a lever unit and a protrusion unit, said protrusion unit being in close contact with the nose unit in the assembly of the lever, holder unit and the nose, enabling the protrusion unit to drive the nose unit to retract into the holder unit when the lever is pressed towards the base unit, said lever unit formed at the opposite end to the protrusion unit on the lever, when the lever unit is pushed, swinging the lever towards the base unit, causing the protrusion unit to drive the nose unit to retract into the lever;
a spindle, penetrating into the base unit, the resilient resetting device and the holder unit, the spindle serving to restrict the extent of rotation of the holder unit and the lever, thereby changing the direction of the extended nose unit after the lever is turned.

2. The inside latch structure of claim 1, wherein the protrusion unit and the nose unit are connected at a position where the nose unit and the holder unit are hinged, and between the hinged positions of the lever and the holder unit.

3. The inside latch structure of claim 1, wherein there is a through channel between the holder unit and the base unit, one end of the through channel being opposite the lever unit of the lever, and penetrating through the through channel being a spindle.

4. The inside latch structure of claim 1, wherein the resilient resetting device comprises a rotor and a torsion spring.
